(19) United States
(12) Patent Application Publication
(10) Pub. No.: US 2005/0208899 A1
(43) Pub. Date: Sep. 22, 2005

(54) Radio communication apparatus and intermittent reception control method

(75) Inventor: Mikio Hanabusa, Yokohama-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/019,132

(22) Filed: Dec. 22, 2004

(30) Foreign Application Priority Data
Dec. 22, 2003 (JP) 2003-424416

(51) Int. Cl. H04B 7/14

(52) U.S. Cl. 455/69; 455/24; 455/78

(57) ABSTRACT

The object of the present invention is to provide a radio communication apparatus including a receiving circuit block including a received signal strength signal circuit, a demodulating circuit block including a noise level determination circuit, an identifying signal determination circuit block including an identifying signal processing circuit and an identifying signal determination circuit, an audio circuit block, a transmitting circuit, an intermittent time control circuit, a timer circuit, and a power supply control circuit. According to a reception state, the power supply control circuit sequentially supplies power only to a required circuit(s) among the receiving circuit block, the demodulating circuit block, and the identifying signal determination circuit block. Meanwhile, an off-time of communication set by a timer circuit according to communication frequency is varied by the intermittent time control circuit.

### BACKGROUND OF THE INVENTION

1. Field of the Invention

The present invention relates to a radio communication apparatus that utilizes a frequency modulation scheme (for example, FSK scheme, FM scheme or the like). In particular, the present invention relates to a radio communication apparatus that employs an intermittent reception scheme, which is capable of changing a power supply control state of a circuit according to a reception state.

2. Description of the Related Art

In a conventional radio receiving apparatus, a power supply control at the time of reception has been performed based on a signal from a control station (refer to, for example Japanese Laid-Open Patent Application No. Hei 6-085856).

FIG. 8 is a block diagram showing a radio receiver using a conventional frequency modulation scheme. In FIG. 8, reference numeral 101 indicates a high frequency amplifier. Reference numerals 1021 and 102Q indicate mixer circuits, respectively. Reference numeral 1031 and 103Q indicate low pass filters, respectively. Reference numerals 1041 and 104Q indicate limiter circuits, respectively. Reference numeral 105 indicates a demodulating circuit. Reference numeral 106 indicates a low pass filter. Reference numeral 107 indicates a comparator circuit (CMP). Reference numeral 108 indicates a 90-degree phase shifter (P. S). Reference numeral 109 indicates a PLL local oscillation circuit. Reference numeral 110 indicates a frequency detecting circuit. Reference numeral 111 indicates a voltage control oscillating circuit (VCO). Reference numeral 112 indicates a loop filter. Reference numeral 113 indicates a control circuit. Reference numeral 114 indicates a synchronizing circuit. Reference numeral 115 indicates an intermittent operating circuit.

Hereinafter, operation of the radio receiver configured as above will be explained. A received wave which is frequency-modulated with a binary digital signal is split into two paths after being amplified by the high frequency amplifier 101. One output of the high frequency amplifier 101 is inputted into the mixer circuit 102I, and the other is inputted into the mixer circuit 102Q. A signal of a local oscillation frequency is also inputted into the 90-degree phase shifter 108 from the voltage control oscillating circuit 111. The 90-degree phase shifter 108 outputs a signal obtained by shifting a phase of an input signal by +45 degrees, and outputs a signal obtained by shifting the phase of the input signal by −45 degrees. The signal obtained by shifting the input signal by +45 degrees is inputted into the mixer circuit 102I. Meanwhile, the signal obtained by shifting the input signal by −45 degrees is inputted into the mixer circuit 102Q.

By taking such a circuit configuration, the output signals from the high frequency amplifier 101 are frequency-converted into two baseband signals, the phases of which are shifted by 90 degrees, respectively, by the mixer circuits 1021 and 102Q to be outputted. Here, since a received frequency and the local oscillation frequency are matched, the baseband signal results in a beat frequency. The low pass filters 1031 and 103Q extract only the baseband signal from output signals of the mixer circuit 1021 and 102Q, and perform band restriction to noise.

The two baseband signals are inputted into the limiter circuits 1041 and 104Q, respectively. Thereby, binary signals I and Q are obtained from the limiter circuits 1041 and 104Q. Respective signal waveforms of signals I and Q are shown in FIG. 9. Incidentally, in FIG. 9, “data” indicates a modulating signal. Frequency detection is performed by inputting the signals I and Q into the demodulating circuit 105.

The demodulating circuit 105 is composed of a D flip-flop 105a as shown in FIG. 10. To the D flip-flop 105a, the signal I is inputted as a clock input C, and the signal Q is inputted as a data input D. According to this configuration, when counting the data at the rising edge of the clock input C, the output L of the D flip-flop 105a will represent a waveform as shown in FIG. 9. That is, when 90 degrees phase shift of the signals I and Q is produced, the output L is also shifted to demodulate the input data.

Thus, a demodulation signal having been demodulated passes through the low pass filter 106 for removing noise, and is inputted into the comparator circuit 107. The demodulation signal is binarized by the comparator circuit 107 and is outputted as a binary digital signal.

The binary digital signal is synchronized with bit stream (bit synchronization) and frame stream (frame synchronization) in the synchronizing circuit 114. The synchronized signal outputted from the synchronizing circuit 114 is then inputted into the intermittent operating circuit 115, so that it outputs an intermittent operation signal BS for making whole receiver perform intermittent operation to the control circuit 113. The control circuit 113 controls the operation of the receiver (high frequency unit), the PLL local oscillation circuit 109, and the voltage control oscillating circuit 111 according to a synchronization state of the receiver. Thereby making it possible to reduce a consumed electric current of the intermittent operation without synchronization drift.

In a technology of reducing a consumed electric current in the above conventional radio receiver, since a base station or the like has been provided and time synchronization between the base station and the receiver for performing communication has been taken, it has been necessary to perform reception only for a predetermined time period.

However, in the case of a communication link between the radio communication apparatuses whose mutual time synchronization is not taken, both parties do not know when communication is started, respectively. As a result, when performing intermittent reception, if head of line blocking of communication caused by the off-time in an intermittent reception operation or the like has been tried to be reduced, it has been difficult to take a long off-time in the intermittent reception operation. However, in order to achieve a reduction in consumed electric current, it is necessary to make the off-time longer in intermittent reception.

As described above, in order for greater availability not to be impaired by the head of line blocking of communication in the intermittent reception operation on the radio communication apparatus, intermittent reception must periodically be performed at a suitable time. Because of that reason, it has been difficult to achieve a further reduction in consumed electric current.

### SUMMARY OF THE INVENTION

The present invention aims to solve the problem in the prior art, and the object thereof is to provide a radio communication apparatus capable of reducing head of line blocking in communication and also achieving a reduction in consumed electric current.

Therefore, according to the present invention, it is configured such that supplying power to a plurality of circuit blocks for example, associated with reception is not started at the same time, but supplying power only to minimum circuit blocks required for a reception determination of intermittent reception is started, and an additional current is not thereby consumed until the circuit blocks are stabilized. It is also configured so that an off-time in intermittent reception may be varied according to a communication state.

Moreover, according to this configuration, in a radio communication apparatus which is able to perform only periodical intermittent reception without a time synchronization between the radio communication apparatuses and uses a frequency modulation scheme, it is configured such that supplying power only to circuit blocks required to determine a received signal is started and supplying power only to required circuit blocks is sequentially started according to a reception state.

Thereby, that makes it possible to suppress consumption of a useless current.

Moreover, since a control system which varies a time of intermittent reception according to communication frequency is provided, when the communication frequency is high, head of line blocking of communication due to the off-time in intermittent reception can be reduced, by taking a short off-time in intermittent reception, whereas when the communication frequency is low, the consumed electric current can be reduced, by taking a long off-time in intermittent reception.

Hereafter, the present invention will be explained in more detail.

According to a first aspect of the present invention, there is provided a radio communication apparatus including a plurality of signal processing circuit blocks, which process a received signal provided through an antenna, at least one of which outputs a reception state determination signal to determine a reception state, and each of which has a different function, a timer circuit which counts an off-time in intermittent reception, a power supply control circuit which controls supplying power to the signal processing circuit blocks according to states of an output signal of the timer circuit and the reception state determination signal.

According to this configuration, since supplying power to the signal processing circuit blocks is controlled according to the state of the reception state determination signal, consumption of a useless current which flows till the operation of each signal processing circuit block is stabilized can be suppressed, thereby making it possible to reduce a consumed electric current.

According to a second aspect of the present invention, there is provided a radio communication apparatus, in a configuration of the first aspect, wherein
a first signal processing circuit block of the signal processing circuit blocks is a receiving circuit block, which receives the signal through the antenna to produce an intermediate frequency signal and to also produce a received signal strength signal which indicates an intensity of an radio wave to be received,
a second signal processing circuit block of the signal processing circuit blocks is a demodulating circuit block, which demodulates the intermediate frequency signal outputted from the receiving circuit block to produce a baseband signal and to also produce a noise level determination signal which indicates whether a noise detection signal corresponding to a noise level in the baseband signal is larger than a threshold, and
a third signal processing circuit block of the signal processing circuit blocks is an identifying signal determination circuit block, which produces an identifying signal determination signal which indicates whether the signal is from a desired remote station based on an identifying signal contained in the baseband signal,
wherein the reception state determination signal includes the received signal strength signal, the noise level determination signal, and the identifying signal determination signal.

The power supply control circuit then controls a start and a stop of supplying power to the receiving circuit block, the demodulating circuit block, and the identifying signal determination circuit block according to the states of the output signal of the timer circuit, the received signal strength signal, the noise level determination signal, and the identifying signal determination signal.

According to this configuration, since the start and the stop of supplying power to the receiving circuit block, the demodulating circuit block, and the identifying signal determination circuit block are controlled according to the states of the received signal strength signal, the noise level determination signal, and the identifying signal determination signal, consumption of a useless current can be suppressed, thereby making it possible to reduce a consumed electric current.

In the above radio communication apparatus according to the second aspect of the present invention, preferably, the power supply control circuit stops supplying power to the receiving circuit block when the received signal strength signal is smaller than a predetermined threshold, stops supplying power to the demodulating circuit block in response to the noise level determination signal when the noise detection signal is larger than a predetermined threshold, and stops supplying power to the identifying signal determination circuit block in response to the identifying signal determination signal when the identifying signal does not indicate the desired remote station.

In the above radio communication apparatus according to the second aspect of the present invention, it further includes an audio circuit block which converts the baseband signal into an audible output, and preferably, the power supply control circuit starts supplying power to the demodulating circuit block when the received signal strength signal is larger than the predetermined threshold, starts supplying power to the identifying signal determination circuit block in response to the noise level determination signal when the noise detection signal is smaller than the predetermined threshold, and starts supplying power to the audio circuit block in response to the identifying signal determination signal when the identifying signal indicates the desired remote station.

In the above radio communication apparatus according to the second aspect of the present invention, it further includes an intermittent time control circuit which controls the off-time in intermittent reception, and preferably, in response to a reception halt due to stopping supplying power from the power supply control circuit to any one of the receiving circuit block, the demodulating circuit block, and the identifying signal determination circuit block, the intermittent time control circuit extends the off-time in intermittent reception by a certain period of time, and in response to reception completion, controls a timer setting time of the timer circuit so as to reset the off-time in intermittent reception to a minimum value.

According to this configuration, the time of intermittent reception is varied according to communication frequency, so that when the communication frequency is high, the off-time in intermittent reception is set shorter, thereby making it possible to reduce head of line blocking of communication due to the off-time in intermittent reception, whereas, when the communication frequency is low, the off-time in intermittent reception is set longer, thereby making it possible to reduce a consumed electric current.

According a third aspect of the present invention, there is provided a radio communication apparatus, in the configuration of the first aspect, wherein
a first signal processing circuit block of the signal processing circuit blocks is a receiving circuit block, which receives the signal through the antenna to produce an intermediate frequency signal and to also produce a received signal strength signal which indicates an intensity of an radio wave to be received, and
a second signal processing circuit block of the signal processing circuit blocks is a demodulating circuit block, which demodulates the intermediate frequency signal outputted from the receiving circuit block to produce a baseband signal and to also produce a noise level determination signal which indicates whether a noise detection signal corresponding to a noise level in the baseband signal is larger than a threshold,
wherein the reception state determination signal includes the received signal strength signal and the noise level determination signal.

The power supply control circuit then controls the start and the stop of supplying power to the receiving circuit block and the demodulating circuit block according to the states of the output signal of the timer circuit, the received signal strength signal, and the noise level determination signal.

According to this configuration, since the start and the stop of supplying power to the receiving circuit block and the demodulating circuit block are controlled according to the states of the received signal strength signal and the noise level determination signal, even when the identifying signal cannot be used, such as conversation with an indefinite number of communication partners, consumption of a useless current can be suppressed, thereby making it possible to reduce a consumed electric current.

In the above radio communication apparatus according to the third aspect of the present invention, preferably, the power supply control circuit stops supplying power to the receiving circuit block when the received signal strength signal is smaller than the predetermined threshold, and stops supplying power to the demodulating circuit block in response to the noise level determination signal when the noise detection signal is larger than the predetermined threshold.

In the above radio communication apparatus according to the third aspect of the present invention, it further includes the audio circuit block which converts the baseband signal into an audible output, and preferably, the power supply control circuit starts supplying power to the demodulating circuit block when the received signal strength signal is larger than the predetermined threshold, and starts supplying power to the audio circuit block in response to the noise level determination signal when the noise detection signal is smaller than the predetermined threshold.

In the above radio communication apparatus according to the third aspect of the present invention, it further includes the intermittent time control circuit which controls the off-time in intermittent reception, and preferably, in response to a reception halt due to stopping supplying power from the power supply control circuit to either of the receiving circuit block or the demodulating circuit block, the intermittent time control circuit extends the off-time in intermittent reception by a certain period of time, and in response to reception completion, controls a timer setting time of the timer circuit so as to reset the off-time in intermittent reception to a minimum value.

According to this configuration, the time of intermittent reception is varied according to communication frequency, so that when the communication frequency is high, the off-time in intermittent reception is set shorter, thereby making it possible to reduce head of line blocking of communication due to the off-time in intermittent reception, whereas, when the communication frequency is low, the off-time in intermittent reception is set longer, thereby making it possible to reduce a consumed electric current.

According to a fourth aspect of the present invention, there is provided a radio communication apparatus, in the configuration of the first aspect, wherein
a first signal processing circuit block of the signal processing circuit blocks is a receiving circuit block, which receives the signal through the antenna to produce an intermediate frequency signal and to also produce a received signal strength signal which indicates an intensity of an radio wave to be received,
a second signal processing circuit block of the signal processing circuit blocks is a demodulating circuit block, which demodulates the intermediate frequency signal outputted from the receiving circuit block to produce a baseband signal, and
a third signal processing circuit block of the signal processing circuit blocks is an identifying signal determination circuit block, which produces an identifying signal determination signal which indicates whether the signal is from a desired remote station based on an identifying signal contained in the baseband signal,
wherein the reception state determination signal includes the received signal strength signal and the identifying signal determination signal.

The power supply control circuit then controls the start and the stop of supplying power to the receiving circuit block and the identifying signal determination circuit block according to the states of the output signal of the timer circuit, the received signal strength signal, and the identifying signal determination signal.

According to this configuration, since the start and the stop of supplying power to the receiving circuit block and the identifying signal determination circuit block are controlled according to the states of the received signal strength signal and the identifying signal determination signal, consumption of a useless current can be suppressed, thereby making it possible to reduce a consumed electric current. Moreover, a noise determination procedure is not performed, so that a reduction in time can be achieved, thereby making it possible to further reduce an unnecessary current in standby mode, and reduce head of line blocking of communication due to the off-time in intermittent reception mode.

In the above radio communication apparatus according to the fourth aspect of the present invention, it further includes the audio circuit block which converts the baseband signal into an audible output, and preferably, the power supply control circuit stops supplying power to the receiving circuit block when the received signal strength signal is smaller than the predetermined threshold, and stops supplying power to the identifying signal determination circuit block in response to the identifying signal determination signal when the identifying signal does not indicate the desired remote station.

In the above radio communication apparatus according to the fourth aspect of the present invention, preferably, the power supply control circuit starts supplying power to the identifying signal determination circuit block when the received signal strength signal is larger than the predetermined threshold, and starts supplying power to the audio circuit block in response to the identifying signal determination signal when the identifying signal indicates the desired remote station.

In the above radio communication apparatus according to the fourth aspect of the present invention, it further includes an intermittent time control circuit which controls the off-time in intermittent reception, and preferably, in response to a reception halt due to stopping supplying power from the power supply control circuit to either of the receiving circuit block, or the identifying signal determination circuit block, the intermittent time control circuit extends the off-time in intermittent reception by a certain period of time, and in response to reception completion, controls a timer setting time of the timer circuit so as to reset the off-time in intermittent reception to a minimum value.

According to this configuration, the time of intermittent reception is varied according to communication frequency, so that when the communication frequency is high, the off-time in intermittent reception is set shorter, thereby making it possible to reduce head of line blocking of communication due to the off-time in intermittent reception, whereas, when the communication frequency is low, the off-time in intermittent reception is set longer, thereby making it possible to reduce a consumed electric current.

In the radio communication apparatus of the above second, third, and fourth aspects, preferably, it further includes a transmitting circuit which generates a transmission signal with a transmission seizing signal to transmit it through the antenna, and an antenna switch which switches transmission/reception by selectively connecting the antenna to the receiving circuit block or the transmitting circuit.

According to a fifth aspect of the present invention, there is provided an intermittent reception control method of controlling supplying power to a radio communication apparatus including a plurality of signal processing circuit blocks, at least one of which outputs a reception state determination signal to determine a reception state, and each of which has a different function, and performing intermittent reception, wherein supplying power to the signal processing circuit blocks is controlled according to a state of the reception state determination signal.

According to this method, since supplying power to the signal processing circuit blocks is controlled according to the state of the reception state determination signal, consumption of a useless current which flows till the operation of each signal processing circuit block is stabilized can be suppressed, thereby making it possible to reduce a consumed electric current.

According to a sixth aspect of the present invention, there is provided an intermittent reception control method of controlling supplying power to a radio communication apparatus which includes a receiving circuit block, a demodulating circuit block, and an identifying signal determination circuit block, and performs intermittent reception, wherein based on a received signal strength signal which indicates an intensity of an radio wave to be received, a noise detection signal which indicates a noise level in a demodulation signal to be demodulated, and a identifying signal contained in the demodulation signal, firstly, it is determined whether the received signal strength signal is smaller than a predetermined threshold, then when the received signal strength signal is smaller than the predetermined threshold, supplying power to the receiving circuit block is stopped, secondly, it is determined whether the noise detection signal is larger than a predetermined threshold, then when the noise detection signal is larger than a predetermined threshold, supplying power to the demodulating circuit block is stopped, and finally, it is determined whether the identifying signal indicates a desired remote station, then when the identifying signal does not indicate the desired remote station, supplying power to the identifying signal determination circuit block is stopped.

According to this method, according to the states of the received signal strength signal, the noise detection signal, and the identifying signal, since the stop of supplying power to the receiving circuit block, the demodulating circuit block, and the identifying signal determination circuit block is controlled, consumption of a useless current can be suppressed, thereby making it possible to reduce a consumed electric current.

In the intermittent reception control method of the above sixth aspect, preferably, when the noise detection signal is larger than the predetermined threshold, supplying power to the receiving circuit block is stopped, when the identifying signal does not indicate the desired remote station, supplying power to the receiving circuit block is stopped, and supplying power to the demodulating circuit block is also stopped.

According to this method, the consumed electric currents can further be reduced.

According to a seventh aspect of the present invention, there is provided an intermittent reception control method of controlling supplying power to a radio communication apparatus which includes a receiving circuit block and a demodulating circuit block, and performs intermittent reception, wherein based on a received signal strength signal which indicates an intensity of an radio wave to be received, and a noise detection signal which indicates a noise level in a demodulation signal to be demodulated, it is determined whether the received signal strength signal is smaller than a predetermined threshold, then when the received signal strength signal is smaller than the predetermined threshold, supplying power to the receiving circuit block is stopped, and next, it is determined whether the noise detection signal is larger than a predetermined threshold, then when the noise detection signal is larger than the predetermined threshold, supplying power to the demodulating circuit block is stopped.

According to this method, since the stop of supplying power to the receiving circuit block and the demodulating circuit block is controlled according to the states of the received signal strength signal and the noise detection signal, even when the identifying signal cannot be used, such as conversation with an indefinite number of communication partners, consumption of a useless current can be suppressed, thereby making it possible to reduce a consumed electric current.

In the intermittent reception control method of the above seventh aspect, preferably, when the noise detection signal is larger than the predetermined threshold, supplying power to the receiving circuit block is stopped.

According to this method, the consumed electric currents can further be reduced.

According to an eighth aspect of the present invention, there is provided an intermittent reception control method of controlling supplying power to the radio communication apparatus which includes a receiving circuit block, a demodulating circuit block, and an identifying signal determination circuit block, and performs intermittent reception, wherein based on the received signal strength signal which indicates an intensity of the radio wave to be received, and the identifying signal contained in the demodulation signal, it is determined whether the received signal strength signal is smaller than a predetermined threshold, then when the received signal strength signal is smaller than the predetermined threshold, supplying power to the receiving circuit block is stopped, and next, it is determined whether the identifying signal indicates a desired remote station, then when the identifying signal does not indicate the desired remote station, supplying power to the identifying signal determination circuit block is stopped.

According to this method, since the stop of supplying power to the receiving circuit block and the identifying signal determination circuit block is controlled according to the states of the received signal strength signal and the identifying signal, consumption of a useless current can be suppressed, and the consumed electric currents can be reduced. In addition, a noise determination procedure is not performed, so that a reduction in time can be achieved, thereby making it possible to further reduce an unnecessary current in standby mode, and reduce head of line blocking of communication due to the off-time in intermittent reception mode.

In the intermittent reception control method of the above eighth aspect, preferably, when the identifying signal does not indicate the desired remote station, supplying power to the receiving circuit block is stopped, and supplying power also to the demodulating circuit block is stopped.

According to this method, the consumed electric currents can further be reduced.

According to a ninth aspect of the present invention, there is provided an intermittent reception control method of controlling supplying power to a radio communication apparatus which includes a receiving circuit block, a demodulating circuit block, an identifying signal determination circuit block, and an audio circuit block, and performs intermittent reception, wherein based on a received signal strength signal which indicates an intensity of an radio wave to be received, a noise detection signal which indicates a noise level in a demodulation signal to be demodulated, and an identifying signal contained in a demodulation signal, firstly, it is determined whether the received signal strength signal is larger than a predetermined threshold, then when the received signal strength signal is larger than the predetermined threshold, supplying power to the demodulating circuit block is started, secondly, it is determined whether the noise detection signal is smaller than a predetermined threshold, then when the noise detection signal is smaller than the predetermined threshold, supplying power to the identifying signal determination circuit block is started, and finally, it is determined whether the identifying signal indicates a desired remote station, then when the identifying signal indicates the desired remote station, supplying power to the audio circuit block is started.

According to this method, since the start of supplying power to the demodulating circuit block, the identifying signal determination circuit block, and the audio circuit block is controlled according to the states of the received signal strength signal, the noise detection signal, and the identifying signal, consumption of a useless current can be suppressed, thereby making it possible to reduce a consumed electric current.

According to a 10th aspect of the present invention, there is provided an intermittent reception control method of controlling supplying power to a radio communication apparatus which includes a receiving circuit block, a demodulating circuit block, and an audio circuit block, and performs intermittent reception, wherein based on a received signal strength signal which indicates an intensity of an radio wave to be received, and a noise detection signal which indicates a noise level in a demodulation signal to be demodulated, it is determined whether the received signal strength signal is larger than a predetermined threshold, then when the received signal strength signal is larger than the predetermined threshold, supplying power to the demodulating circuit block is started, and next, it is determined whether the noise detection signal is smaller than a predetermined threshold, then when the noise detection signal is smaller than the predetermined threshold, supplying power to the audio circuit block is started.

According to this method, since the start of supplying power to the demodulating circuit block and the audio circuit block is controlled according to the states of the received signal strength signal and the noise detection signal, even when the identifying signal cannot be used, such as conversation with an indefinite number of communication partners, consumption of a useless current can be suppressed, thereby making it possible to reduce a consumed electric current.

According to a 11th aspect of the present invention, there is provided an intermittent reception control method of controlling supplying power to a radio communication apparatus which includes a receiving circuit block, a demodulating circuit block, an identifying signal determination circuit block, and an audio circuit block, and performs intermittent reception, wherein based on a received signal strength signal which indicates an intensity of an radio wave to be received, and an identifying signal contained in a demodulation signal, it is determined whether the received signal strength signal is larger than a predetermined threshold, then when the received signal strength signal is larger than the predetermined threshold, supplying power to the identifying signal determination circuit block is started, and next, it is determined whether the identifying signal indicates a desired remote station, then when the identifying signal indicates the desired remote station, supplying power to the audio circuit block is started.

According to this method, since the start of supplying power to the identifying signal determination circuit block and the audio circuit block is controlled according to the states of the received signal strength signal and the identifying signal, consumption of a useless current can be suppressed, thereby making it possible to reduce a consumed electric current. In addition, the noise determination procedure is not performed, so that a reduction in time can be achieved, thereby making it possible to further reduce an unnecessary current in standby mode, and reduce head of line blocking of communication due to the off-time in intermittent reception mode.

In the intermittent reception control method according to the ninth, the 10th, and the 11th aspects, preferably, supplying power to the receiving circuit block is periodically started.

According to a 12th aspect of the present invention, there is provided an intermittent reception control method, wherein when a received signal is not received for a predetermined time period or longer, an off-time in intermittent reception is set longer, and the off-time in intermittent-reception is set shorter for a predetermined time period after reception completion or transmission completion. This 12th invention will become more effective by combining with the fifth through the 11th inventions.

According to this method, the time of intermittent reception is varied according to communication frequency, so that when the communication frequency is high, the off-time in intermittent reception is set shorter, thereby making it possible to reduce head of line blocking of communication due to the off-time in intermittent reception, whereas, when the communication frequency is low, the off-time in intermittent reception is set longer, thereby making it possible to reduce a consumed electric current.

According to an intermittent reception control method of a 13th aspect of the present invention, the off-time in intermittent reception is varied longer gradually with the passage of time after the reception or the transmission is completed. This 13th invention will become more effective by combining with the fifth through the 11th inventions.

According to this method, the time of intermittent reception is varied according to communication frequency, so that when the communication frequency is high, the off-time in intermittent reception is set shorter, thereby making it possible to reduce head of line blocking of communication due to the off-time in intermittent reception, whereas, when the communication frequency is low, the off-time in intermittent reception is set longer, thereby making it possible to reduce a consumed electric current.

According to a 14th aspect of the present invention, there is provided a semiconductor integrated circuit device for wireless communications, wherein the radio communication apparatus of any one of the first through the fourth aspects is integrated on a semiconductor substrate.

According to this method, an effect similar to that of the radio communication apparatus of any one of the first through the fourth aspects is provided.

According to a 15th aspect of the present invention, there is provided a module for wireless communications, wherein the radio communication apparatus of any one of the first, the second, the third, and the fourth aspects is mounted on a circuit board.

According to this method, an effect similar to that of the radio communication apparatus of any one of the first through the fourth aspects is provided.

According to a 16th aspect of the present invention, there is provided a radio communication system which is configured using the radio communication apparatus of any one of the first through the fourth aspects the present invention.

According to this method, an effect similar to that of the radio communication apparatus of any one of the first through the fourth aspects of the present invention is provided.

As described above, according to the radio communication apparatus with regard to the present invention, when neither of radio communication apparatuses has means of synchronizing with each other, the state of the received signal is determined at the time set by the timer to sequentially control supplying power to each circuit block of the radio communication apparatus and to thereby operate only required circuit blocks, so that there can be provided the radio communication apparatus which can achieve a reduction in consumed electric current.

Moreover, according to the intermittent reception control method of the present invention, when neither of radio communication apparatuses has means of synchronizing with each other, the state of the received signal is determined at the time set by the timer to sequentially control supplying power to each circuit block of the radio communication apparatus and to thereby operate only required circuit blocks, so that thereby making it possible to achieve a reduction in consumed electric current.

Moreover, according to the intermittent reception control method in accordance with the present invention, the time of the timer which determines the off-time in intermittent reception may be varied according to communication frequency, so that head of line blocking of communication can be reduced and a reduction in consumed electric current can be achieved.

### BRIEF DESCRIPTION OF THE DRAWINGS

FIG. 1 is a block diagram showing a configuration of a radio communication apparatus in accordance with a first embodiment of the present invention;

FIG. 2 is a flow chart showing a control method of radio communication apparatuses according to a second and a fifth embodiments of the present invention;

FIG. 3 is a flow chart showing a control method of radio communication apparatuses according to a third and a sixth embodiments of the present invention;

FIG. 4 is a flow chart showing a control method of radio communication apparatuses according to a fourth and a seventh embodiments of the present invention;

FIG. 5 is a flow chart showing a control method of a radio communication apparatus according to an eighth embodiment of the present invention;

FIG. 6 is a timing chart showing operation of the radio communication apparatus according to the first embodiment of the present invention;

FIG. 7 is a timing chart showing the control method of the radio communication apparatus according to the eighth embodiment of the present invention;

FIG. 8 is a block diagram showing a configuration of a conventional radio communication apparatus;

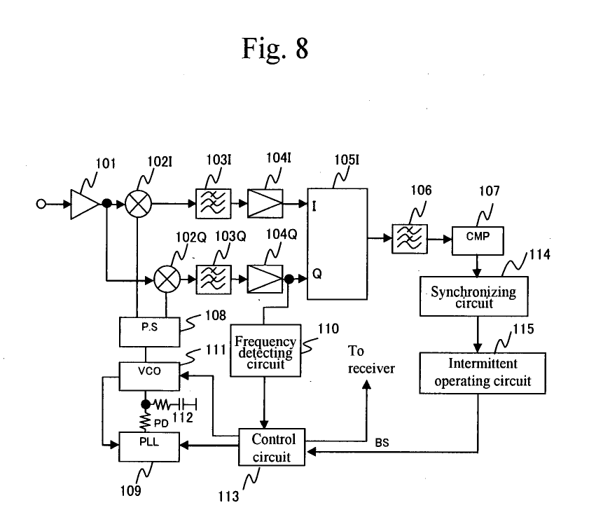

FIG. 9 is a timing chart showing operation of the conventional radio communication apparatus; and

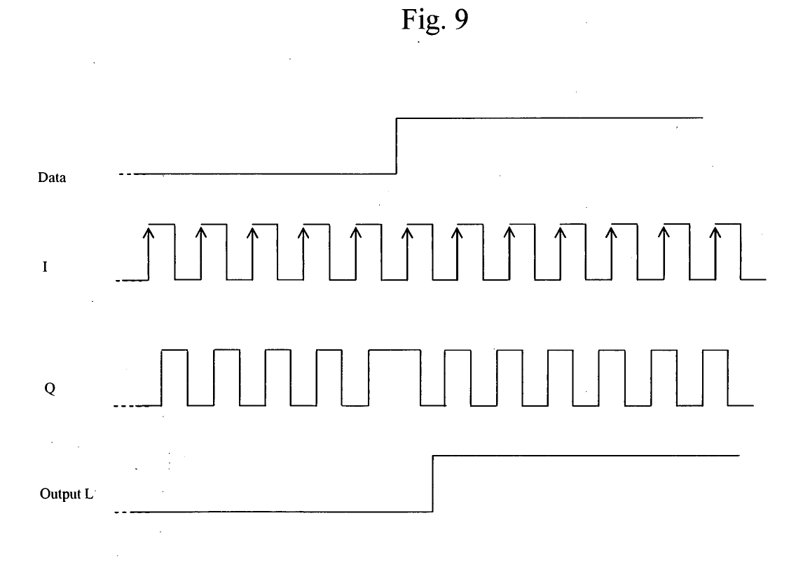

FIG. 10 is a block diagram showing a configuration of a demodulating circuit according to the conventional radio communication apparatus.

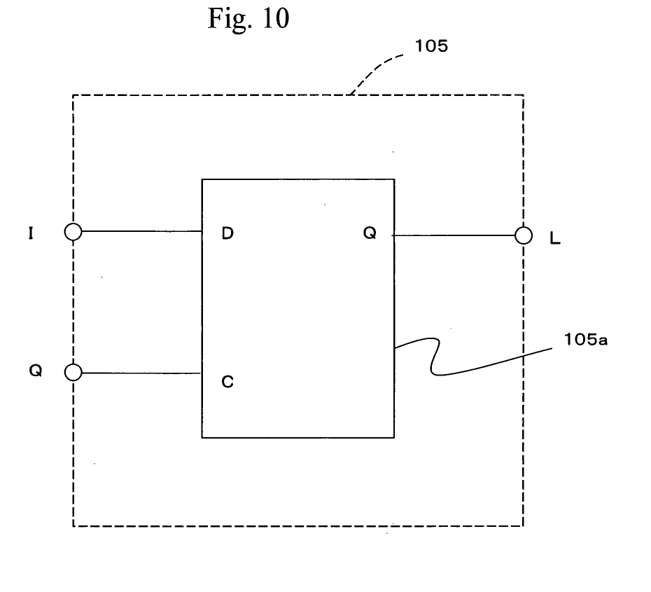

### DETAILED DESCRIPTION OF THE PREFERRED EMBODIMENTS

Hereafter, referring to the drawings, embodiments of radio communication apparatuses in accordance with the present invention will be explained in detail.

### First Embodiment

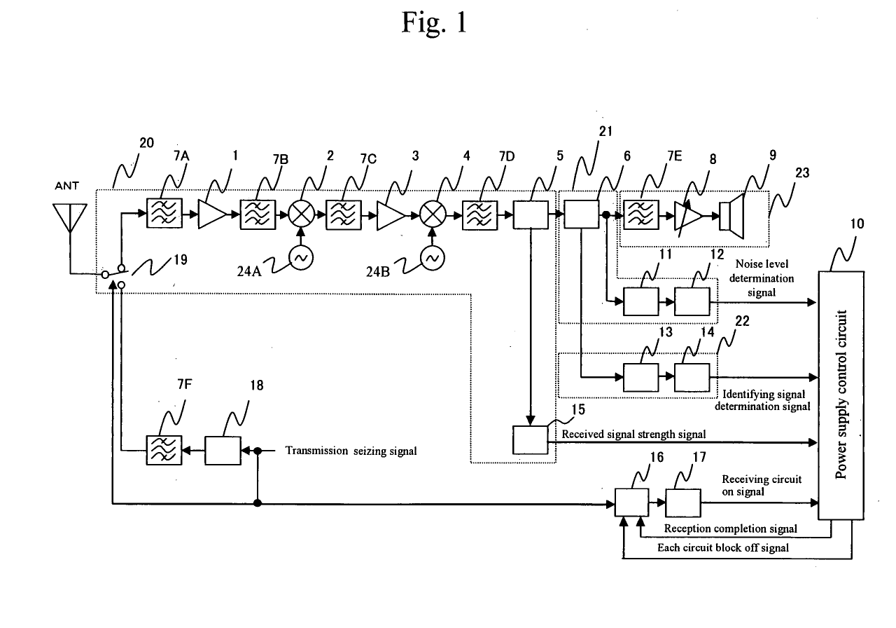

FIG. 1 is a block diagram showing a configuration of a radio communication apparatus according to a first embodiment of the present invention.

As shown in FIG. 1, this radio communication apparatus includes a receiving circuit block 20 which enters a received signal through an antenna ANT that receives an radio wave from a communication station, and amplifies and convert frequency into intermediate frequency the received signal; a demodulating circuit block 21 which demodulates the intermediate frequency signal into an audio signal; an identifying signal determination circuit block 22 which identifies and determines an identifying signal contained in the demodulated audio signal; an audio circuit block 23 which amplifies the demodulated audio signal and sounds a loudspeaker; a transmitting circuit 18 which modulates the audio signal and the identifying signal to a carrier wave to be transmitted; a power supply control circuit 10 which controls supplying power to the receiving circuit block 20, the demodulating circuit block 21, the identifying signal determination circuit block 22, and the audio circuit block 23; an intermittent time control circuit 16 which controls intermittent reception according to a reception state; and a timer circuit 17 which counts an intermittent time according to a signal from the power supply control circuit 10, and provides a seizing signal to the power supply control circuit 10, and it is configured so that supplying power to only circuit blocks required to determine the reception state is started, and the time of intermittent reception is controlled according to the determined reception state. Reference numeral 7F represents a band pass filter provided on an output side of the transmitting circuit 18.

The receiving circuit block 20 includes a high frequency amplifier 1, a mixer circuit 2, an amplifier 3, another mixer circuit 4, a limiter amplifier 5, a received signal strength signal circuit 15, band pass filters 7A, 7B, 7C, and 7D, and local oscillators 24A and 24B.

The demodulating circuit block 21 is composed of a demodulator 6, a noise detection circuit 11, and a noise level determination circuit 12.

The identifying signal determination circuit block 22 is composed of an identifying signal processing circuit 13 and an identifying signal determination circuit 14.

The audio circuit block 23 is composed of a band pass filter 7E, a power amplifier 8, and a loudspeaker 9.

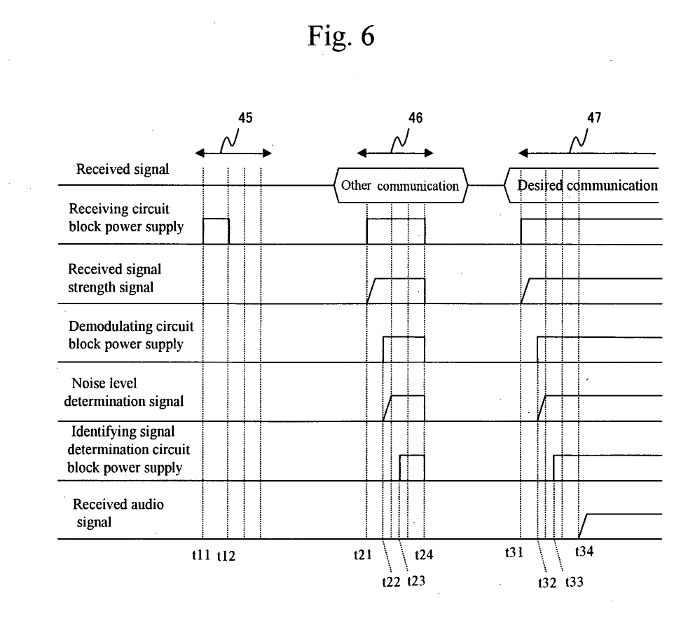

Next, operation of this radio communication apparatus will be explained using FIGS. 1 and 6. FIG. 6 is a timing chart showing the operation of the radio communication apparatus of FIG. 1. In FIG. 6, a section 45 represents a non-signal reception period. A section 46 represents another communication reception period different from a desired communication reception period. A section 47 represents a desired communication reception period.

There are also shown in FIG. 6 a state of the power supply of the receiving circuit block 20, a received signal strength signal, a state of the power supply of the demodulating circuit block 21, a noise level determination signal, a state of the power supply of the identifying signal determination circuit block 22, and a state of a received audio signal.

Here, as for the state of supplying power to the receiving circuit block 20, high level represents a state where power is supplied, and low level represents a state where power is not supplied. As for the received signal strength signal, high level represents a state where field intensity is high, and low level represents a state where field intensity is low. As for the state of supplying power to the demodulating circuit block 21, high level represents a state where power is supplied, and low level represents a state where power is not supplied. As for the noise level determination signal, high level represents a state where a noise level is low, and low level represents a state where the noise level is high. As for the state of supplying power to the identifying signal determination circuit block 22, high level represents a state where power is supplied, and low level represents a state where power is not supplied. As for the state of the received audio signal, High level represents a state where voice is outputted, and low level represents a state where the voice is not outputted.

When a predetermined reception time (time t₁₁, t₂₁, and t₃₁) arrives, a receiving circuit ON signal is inputted into the power supply control circuit 10 from the timer circuit 17. As a result, the power supply control circuit 10 supplies power to the receiving circuit block 20. A timer setting time of the timer circuit 17 is set by the intermittent time control circuit 16, into which a reception completion signal outputted from the power supply control circuit 10 and each circuit block OFF signal are inputted. The reception completion signal is outputted from the power supply control circuit 10 when intermittent reception is completed. Meanwhile, the each circuit block OFF signal is outputted from the power supply control circuit 10, respectively, when the power supply control circuit 10 turns off power to the receiving circuit block 20, the demodulating circuit block 21, and the identifying signal determination circuit block 22.

When power is supplied to the receiving circuit block 20, the radio wave received through the antenna ANT is inputted into the receiving circuit block 20 through an antenna switch 19. This radio wave is converted into an intermediate frequency signal using a local oscillation signal by the receiving circuit block 20. The intermediate frequency signal is then provided from the limiter amplifier 5 as its output. A received signal strength signal according to an amplitude of the received signal is then outputted from the received signal strength signal circuit 15 simultaneously. This received signal strength signal is inputted into the power supply control circuit 10.

When the received signal strength signal is lower than a predetermined threshold, the power supply control circuit 10 determines that the received wave is not received. In this case, the power supply control circuit 10 stops supplying power to the receiving circuit block 20 (time t12).

On the other hand, when the received signal strength signal is higher than the predetermined threshold, the power supply control circuit 10 determines that the received wave is received. In this case, the power supply control circuit 10 supplies power to the demodulating circuit block 21 (time t22 and t32).

When power is supplied to the demodulating circuit block 21, the demodulator 6 will start operation. As a result, the intermediate frequency signal outputted from the limiter amplifier 5 is converted into a baseband signal by the demodulator 6. At this time, noise other than a signal associated with communication is detected from the baseband signal by the noise detection circuit 11. The noise detection circuit 11 then outputs an amplitude level of this noise to the noise level determination circuit 12 as a noise detection signal (voltage value).

The noise level determination circuit 12 compares the amplitude of the noise detection signal with a predetermined threshold. As a result of this comparison, when it is determined that the noise level is higher than the predetermined threshold, it means that the received signal is not suitable for communication. For that reason, the noise level determination circuit 12 outputs to the power supply control circuit 10 the noise level determination signal indicating that the noise level is higher. As a result, the power supply control circuit 10 stops supplying power to the receiving circuit block 20 and the demodulating circuit block 21.

On the other hand, when it is determined that the noise level is lower than the predetermined threshold, it means that the received signal is suitable for communication. For that reason, the noise level determination circuit 12 outputs to the power supply control circuit 10 the noise level determination signal corresponding to it, that is, the noise level determination signal indicating that the noise level is low. As a result, the power supply control circuit 10 supplies power to the identifying signal determination circuit block 22 (time t23 and t33).

When power is supplied to the identifying signal determination circuit block 22, the identifying signal processing circuit 13 will extract the identifying signal from the baseband signal outputted from the demodulator 6, and will output it to the identifying signal determination circuit 14. The identifying signal determination circuit 14 compares the identifying signal contained in the received signal with an identifying signal from a predetermined desired communication partner, and determines whether it is from the predetermined desired communication partner.

When the identifying signal is not matched therewith, the identifying signal determination circuit 14 outputs to the power supply control circuit 10 an identifying signal determination signal indicating that the identifying signal is not matched therewith. As a result, the power supply control circuit 10 stops supplying power to the receiving circuit block 20, the demodulating circuit block 21, and the identifying signal determination circuit block 22 (time t24).

On the other hand, when the identifying signal is matched therewith, the identifying signal determination circuit 14 outputs to the power supply control circuit 10 the identifying signal determination signal indicating that the identifying signal has been matched therewith. As a result, the power supply control circuit 10 supplies power to the audio circuit block 23 (time t34).

As a result, sound (audible sound) corresponding to the received signal received through the receiving antenna ANT will be outputted from the loudspeaker 9.

In addition, in this radio communication apparatus, when a transmission seizing signal is inputted, while the transmitting circuit 18 starts a transmission operation, the antenna switch 19 is switched for emitting a transmission wave from the antenna ANT.

Meanwhile, when an intermittent reception operation is completed, the reception completion signal is outputted from the power supply control circuit 10 to the intermittent time control circuit 16. In addition, when supplying power to the receiving circuit block 20, the demodulating circuit block 21, and the identifying signal determination circuit block 22 is turned off by the power supply control circuit 10, the each circuit block OFF signals, that is, a receiving circuit block OFF signal, a demodulating circuit block OFF signal, and an identifying signal determination circuit block OFF signal are outputted from the power supply control circuit 10 to the intermittent time control circuit 16. As a result, the intermittent time control circuit 16 varies the timer setting time of the timer circuit 17 based on above two types of signal.

According to this embodiment, following effects will be obtained. Intermittent reception has conventionally been performed only in communication in which synchronization is taken between the communication apparatuses. This embodiment makes it possible to effectively perform such intermittent reception in a communication scheme out of synchronization. That is, it is configured so that supplying power to each circuit block may be controlled according to the state of the received signal to operate only required circuit blocks in respective situations. Thus, by performing such a form as the intermittent reception operation which repeats the above power supply control operation in reception standby mode, a reduction in consumed electric current can be achieved.

Meanwhile, according to the embodiment described above, although both of the noise level detection signal and the identifying signal determination signal have been used, a configuration where either of them is not used may also be included in this embodiment. Here, when not using the noise level detection signal, both of the noise detection circuit 11 and the noise level determination circuit 12 may be deleted. In addition, when not using the identifying signal determination signal, both of the identifying signal processing circuit 13 and the identifying signal determination circuit 14 may be deleted.

The former is suitable when the communication apparatus is used at a location in a favorable communication environment. According to this configuration, the noise determination procedure is not performed, so that a reduction in time can be achieved. Moreover, this embodiment makes it possible to further reduce an unnecessary current in standby mode, and reduce head of line blocking of communication due to the off-time in intermittent reception mode.

The latter is suitable when communication is performed without specifying a communication partner. According to this configuration, even when the identifying signal cannot be used, such as conversation with an indefinite number of communication partners, an unnecessary current in standby mode can be reduced.

### Second Embodiment

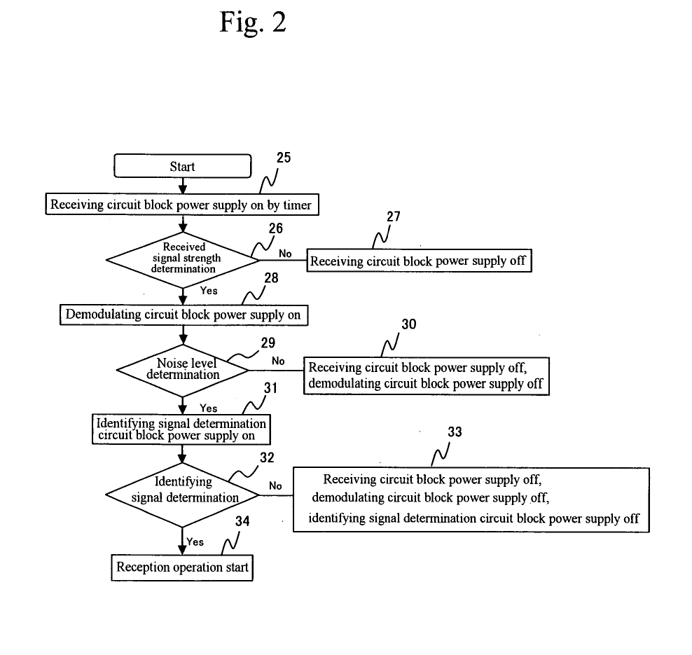

FIG. 2 is a flow chart showing an intermittent reception control method of a second embodiment of the present invention. Speaking more specifically, it is the flow chart showing a method of controlling power in the radio communication apparatus which performs intermittent reception shown in FIG. 1.

This control method will be explained using FIG. 2. When a predetermined reception timing arrives, power is supplied to the receiving circuit block 20 according to a procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to a procedure 26 for determining the received signal strength. When it is determined that the received signal strength signal is lower than the threshold, supplying power to the receiving circuit block 20 is stopped according to a procedure 27 for stopping supplying power to the receiving circuit block.

When it is determined that the received signal strength signal is higher than the threshold, supplying power to the demodulating circuit block 21 is started according to a procedure 28 for activating supplying power to the demodulating circuit block. When power is supplied to the demodulating circuit block 21, the received signal is converted into the baseband signal and noise other than the signal associated with communication is extracted. The noise level is then compared with a predetermined threshold according to a noise level determination procedure 29. When the noise level is higher than the threshold, it is determined that the situation is not suitable for communication, so that supplying power to the receiving circuit block 20 and the demodulating circuit block 21 is stopped according to a procedure 30 for stopping supplying power to the receiving circuit block and the demodulating circuit block. Incidentally, although supplying power to the demodulating circuit block 21 is started after determined that the received signal strength signal is higher than the threshold according to the procedure 26 for determining the received signal strength in FIG. 2, it may be started simultaneously with supplying power to the receiving circuit block 20. In this case, after determined that the received signal strength signal is higher than the threshold, the noise level determination procedure 29 is subsequently performed.

When the noise level is lower than the threshold, it is determined that circumstances are suitable for communication, so that supplying power to the identifying signal determination circuit block 22 is started according to a procedure 31 for activating identifying signal determination circuit block. When supplying power to the identifying signal determination circuit block 22 is started, the identifying signal will be extracted from the received baseband signal by the identifying signal determination circuit block 22. It is determined whether this identifying signal is matched with the identifying signal from a desired communication partner according to a procedure 32 for determining the identifying signal. When the identifying signal is not matched therewith, supplying power to the receiving circuit block 20, the demodulating circuit block 21, and the identifying signal determination circuit block 22 is stopped according to a procedure 33 for stopping supplying power to the receiving circuit block, the demodulating circuit block, and the identifying signal determination circuit block. Incidentally, although supplying power to the identifying signal determination circuit block 22 is started after determined that the noise level is lower according to the noise level determination procedure 29 in FIG. 2, it may be start simultaneously with supplying power to the receiving circuit block 20, and it may also be started simultaneously with supplying power to the demodulating circuit block 21. In this case, after determined that the noise level is lower, the procedure 32 for determining the identifying signal is subsequently performed.

When the identifying signal is matched therewith, according to the reception operation start procedure 34, supplying power to the audio circuit block 23 is started to start the reception operation. Meanwhile, supplying power to the audio circuit block 23 may be started simultaneously with supplying power to the receiving circuit block 20, may be started simultaneously with supplying power to the demodulating circuit block 21, and may be started simultaneously with supplying power to the identifying signal determination circuit block 22.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength, the noise level, and the identifying signal are determined in this order, and when they are determined not to be a desired reception signal according to the determination result, supplying power to each circuit block is stopped. In the intermittent reception operation in standby mode, an unnecessary current can be reduced by repeating this operation.

### Third Embodiment

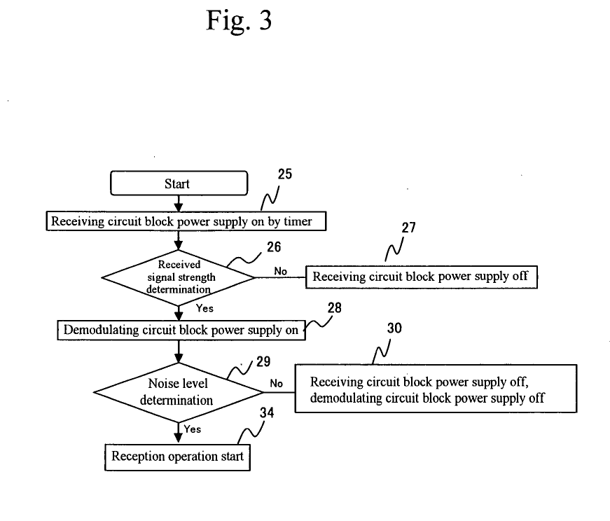

FIG. 3 is a flow chart showing an intermittent reception control method according to a third embodiment of the present invention. Speaking more specifically, it is the flow chart showing a method of controlling power in the radio communication apparatus which performs intermittent reception shown in FIG. 1. This flow chart is obtained by deleting the procedure 32 for determining the identifying signal and the procedure 33 for stopping supplying power to the receiving circuit block, the demodulating circuit block, and the identifying signal determination circuit block from the flow chart (FIG. 2) which shows the control method of the second embodiment.

This control method will be explained using FIG. 3. When a predetermined reception timing arrives, power is supplied to the receiving circuit block 20 according to the procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to the procedure 26 for determining the received signal strength. When it is determined that the received signal strength signal is lower than the threshold, supplying power to the receiving circuit block 20 is stopped according to the procedure 27 for stopping supplying power to the receiving circuit block.

When it is determined that the received signal strength signal is higher than the threshold, supplying power to the demodulating circuit block 21 is started according to the procedure 28 for activating supplying power to the demodulating circuit block. When power is supplied to the demodulating circuit block 21, the received signal is converted into the baseband signal and noise other than the signal associated with communication is extracted. The noise level is then compared with a predetermined threshold according to the noise level determination procedure 29. When the noise level is higher than the threshold, it is determined that the situation is not suitable for communication, supplying power to the receiving circuit block 20 and the demodulating circuit block 21 is stopped according to the procedure 30 for stopping supplying power to the receiving circuit block and the demodulating circuit block. Meanwhile, although supplying power to the demodulating circuit block 21 is started after determined that the received signal strength signal is higher than the threshold according to the procedure 26 for determining the received signal strength in FIG. 3, it may be started simultaneously with supplying power to the receiving circuit block 20. In this case, after determined that the received signal strength signal is higher than the threshold, the noise level determination procedure 29 is subsequently performed.

When the noise level is lower than the threshold, it is determined that circumstances are suitable for communication, so that according to the reception operation start procedure 34, supplying power to the audio circuit block 23 is started to start the reception operation. Meanwhile, supplying power to the audio circuit block 23 may be started simultaneously with supplying power to the receiving circuit block 20, and may also be started simultaneously with supplying power to the demodulating circuit block 21.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength and the noise level are determined in this order, when they are determined not to be a desired reception signal according to the determination result, supplying power to each circuit block is stopped. In the intermittent reception operation in standby mode, an unnecessary current can be reduced by repeating this operation.

In particular, even when the identifying signal cannot be used, such as conversation with an indefinite number of communication partners, an unnecessary current in standby mode can be reduced.

### Fourth Embodiment

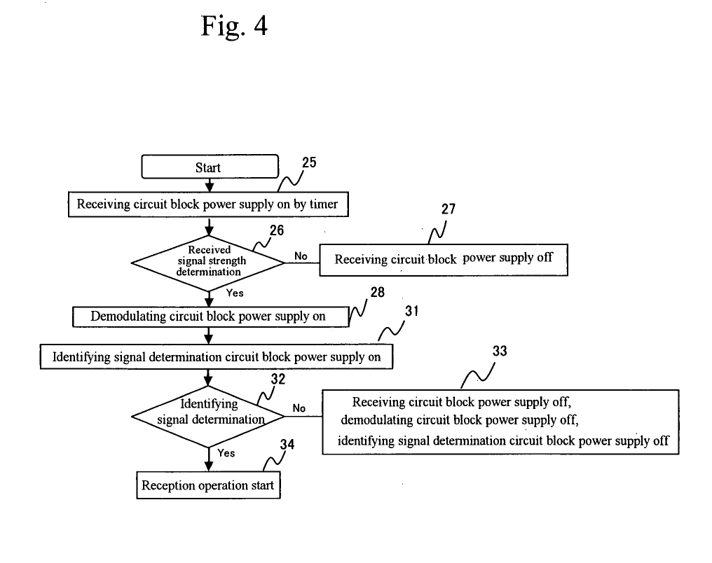

FIG. 4 is a flow chart showing an intermittent reception control method of a fourth embodiment of the present invention. Speaking more specifically, it is the flow chart showing a method of controlling power in the radio communication apparatus which performs intermittent reception shown in FIG. 1. This flow chart is obtained by deleting the noise level determination procedure 29 and the procedure 30 for stopping supplying power to the receiving circuit block and the demodulating circuit block from the flow chart (FIG. 2) which shows the control method of the second embodiment.

This control method will be explained using FIG. 4. When a predetermined reception timing arrives, power is supplied to the receiving circuit block 20 according to the procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to the procedure 26 for determining the received signal strength. When it is determined that the received signal strength signal is lower than the threshold, supplying power to the receiving circuit block 20 is stopped according to the procedure 27 for stopping supplying power to the receiving circuit block.

When it is determined that the received signal strength signal is higher than the threshold, supplying power to the demodulating circuit block 21 is started according to the procedure 28 for activating supplying power to the demodulating circuit block.

When power is supplied to the demodulating circuit block 21, the received signal is converted into the baseband signal.

Next, supplying power to the identifying signal determination circuit block 22 is started according to the procedure 31 for activating the identifying signal determination circuit block. Thereby, the identifying signal is extracted from the received baseband signal by the identifying signal determination circuit block 22. It is determined whether this identifying signal is matched with the identifying signal from a desired communication partner according to the procedure 32 for determining the identifying signal. When the identifying signal is not matched therewith, supplying power to the receiving circuit block 20, the demodulating circuit block 21, and the identifying signal determination circuit block 22 is stopped according to the procedure 33 for stopping supplying power to the receiving circuit block, the demodulating circuit block, and the identifying signal determination circuit block. Meanwhile, although supplying power to the demodulating circuit block 21 and the supplying power identifying signal determination circuit block 22 is started after determined that the received signal strength signal is higher than the threshold according to the procedure 26 for determining the received signal strength in FIG. 4, it may be started simultaneously with supplying power to the receiving circuit block 20. In this case, after determined that the received signal strength signal is higher than the threshold, the procedure 32 for determining the identifying signal is subsequently performed.

When the identifying signal is matched therewith, according to the reception operation start procedure 34, supplying power to the audio circuit block 23 is started to start the reception operation. Meanwhile, supplying power to the audio circuit block 23 may be started simultaneously with supplying power to the receiving circuit block 20, may be started simultaneously with supplying power to the demodulating circuit block 21, and may be started simultaneously with supplying power to the identifying signal determination circuit block 22.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength and the identifying signal are determined in this order, and when they are determined not to be a desired reception signal according to the determination result, supplying power to each circuit block is stopped. In the intermittent reception operation in standby mode, an unnecessary current can be reduced by repeating this operation.

In particular, in an environment where the received signal includes few noise, the noise determination procedure is not performed, so that a reduction in time can be achieved, thereby making it possible to further reduce an unnecessary current in standby mode, and also reduce head of line blocking of communication due to the off-time in intermittent reception mode.

### Fifth Embodiment

FIG. 2 is a flow chart showing an intermittent reception control method of a fifth embodiment of the present invention. Speaking more specifically, it is the flow chart showing a method of controlling power in the radio communication apparatus which performs intermittent reception shown in FIG. 1.

This control method will be explained using FIG. 2. When a predetermined reception timing arrives, power is supplied to the receiving circuit block 20 according to the procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to the procedure 26 for determining the received signal strength. When it is determined that the received signal strength signal is higher than the threshold, supplying power to the demodulating circuit block 21 is started according to the procedure 28 for activating supplying power to the demodulating circuit block.

When power is supplied to the demodulating circuit block 21, the received signal is converted into the baseband signal and noise other than the signal associated with communication is extracted. The noise level is then compared with a predetermined threshold according to the noise level determination procedure 29. When the noise level is lower than the threshold, it is determined that circumstances are suitable for communication, and supplying power to the identifying signal determination circuit block 22 is started according to the procedure 31 for activating the identifying signal determination circuit block.

When supplying power to the identifying signal determination circuit block 22 is started, the identifying signal is extracted from the received baseband signal by the identifying signal determination circuit block 22. It is determined whether this identifying signal is matched with the identifying signal from a desired communication partner according to the procedure 32 for determining the identifying signal. When the identifying signal is matched therewith, according to the reception operation start procedure 34, supplying power to the audio circuit block 23 is started to start the reception operation.

When it is determined that the received signal strength signal is lower than the threshold according to the procedure 26 for determining the received signal strength, supplying power to the receiving circuit block 20 is stopped according to the procedure 27 for stopping supplying power to the receiving circuit block. Meanwhile, when it is determined that the received signal strength signal is lower than the threshold, supplying power to the receiving circuit block 20 may not be stopped.

When the noise level is higher than the threshold, it is determined that the situation is not suitable for communication according to the noise level determination procedure 29, and supplying power to the receiving circuit block 20 and the demodulating circuit block 21 is stopped according to the procedure 30 for stopping supplying power to the receiving circuit block and the demodulating circuit block. Meanwhile, when it is determined that the situation is not suitable for communication, supplying power to the receiving circuit block 20 and the demodulating circuit block 21 may not be stopped.

When it is determined that the identifying signal is not matched therewith according to the procedure 32 for determining the identifying signal, according to the procedure 33 for stopping supplying power to the receiving circuit block, the demodulating circuit block, and the identifying signal determination circuit block, supplying power to the receiving circuit block 20, the demodulating circuit block 21, and the identifying signal determination circuit block 22 is stopped. Meanwhile, when it is determined that the identifying signal is not matched therewith, supplying power to the receiving circuit block 20, the demodulating circuit block 21, and the identifying signal determination circuit block 22 may not be stopped.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength, the noise level, and the identifying signal are determined in this order, and when they are determined to be a desired reception signal according to the determination result, supplying power to each circuit block is sequentially started. In the intermittent reception operation in standby mode, supplying only power to required circuit blocks is started by repeating this operation, so that an unnecessary current can be reduced.

### Sixth Embodiment

FIG. 3 is a flow chart showing an intermittent reception control method of a sixth embodiment of the present invention. Speaking more specifically, it is the flow chart showing a method of controlling power in the radio communication apparatus which performs intermittent reception shown in FIG. 1. This flow chart is obtained by deleting the identifying signal determination procedure 32 and the procedure 33 for stopping supplying power to the receiving circuit block, the demodulating circuit block, and the identifying signal determination circuit block from the flow chart (FIG. 2) which shows the control method of the fifth embodiment.

This control method will be explained using FIG. 3. When a predetermined reception timing arrives, power is supplied to the receiving circuit block 20 according to the procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to the procedure 26 for determining the received signal strength. When it is determined that the received signal strength signal is higher than the threshold, supplying power to the demodulating circuit block 21 is started according to the procedure 28 for activating supplying power to the demodulating circuit block.

When power is supplied to the demodulating circuit block 21, the received signal is converted into the baseband signal and noise other than the signal associated with communication is extracted. The noise level is then compared with a predetermined threshold according to the noise level determination procedure 29. When the noise level is lower than the threshold, it is determined that circumstances are suitable for communication, and according to the reception operation start procedure 34, supplying power to the audio circuit block 23 is started to start the reception operation.

When it is determined that the received signal strength signal is lower than the threshold according to the procedure 26 for determining the received signal strength, supplying power to the receiving circuit block 20 is stopped according to the procedure 27 for stopping supplying power to the receiving circuit block. Meanwhile, when it is determined that the received signal strength signal is lower than the threshold, supplying power to the receiving circuit block 20 may not be stopped.

When the noise level is higher than the threshold, it is determined that the situation is not suitable for communication according to the noise level determination procedure 29, and supplying power to the receiving circuit block 20 and the demodulating circuit block 21 is stopped according to the procedure 30 for stopping supplying power to the receiving circuit block and the demodulating circuit block. Meanwhile, when it is determined that the situation is not suitable for communication, supplying power to the receiving circuit block 20 and the demodulating circuit block 21 may not be stopped.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength and the noise level are determined in this order, and when they are determined to be a desired reception signal according to the determination result, supplying power to each circuit block is sequentially started. In the intermittent reception operation in standby mode, supplying only power to required circuit blocks is started by repeating this operation, so that an unnecessary current can be reduced.

In particular, even when the identifying signal cannot be used, such as conversation with an indefinite number of communication partners, an unnecessary current in standby mode can be reduced.

### Seventh Embodiment

FIG. 4 is a flow chart showing an intermittent reception control method of a seventh embodiment of the present invention. Speaking more specifically, it is the flow chart showing a method of controlling power in the radio communication apparatus which performs intermittent reception shown in FIG. 1. This flow chart is obtained by deleting the noise level determination procedure 29 and the procedure 30 for stopping supplying power to the receiving circuit block and the demodulating circuit block from the flow chart (FIG. 2) which shows the control method of the second embodiment.

This control method will be explained using FIG. 4. When a predetermined reception timing arrives, power is supplied to the receiving circuit block 20 according to the procedure 25 for activating supplying power to the receiving circuit block by the timer circuit 17. Thereby, based on the received signal provided through the antenna, the received signal strength signal is outputted from the received signal strength signal circuit 15. The received signal strength signal outputted from the received signal strength signal circuit 15 is then compared with a predetermined threshold according to the procedure 26 for determining the received signal strength. When it is determined that the received signal strength signal is higher than the threshold, supplying power to the demodulating circuit block 21 is started according to the procedure 28 for activating supplying power to the demodulating circuit block.

When power is supplied to the demodulating circuit block 21 and the identifying signal determination circuit block 22, the received signal is converted into the baseband signal.

Next, supplying power to the identifying signal determination circuit block 22 is started according to the procedure 31 for activating the identifying signal determination circuit block. Thereby, the identifying signal is extracted from the received baseband signal by the identifying signal determination circuit block 22, and it is determined whether this identifying signal is matched with the identifying signal from a desired communication partner according to the procedure 32 for determining the identifying signal. When the identifying signal is matched therewith, according to the reception operation start procedure 34, supplying power to the audio circuit block 23 is started to start the reception operation.

When it is determined that the received signal strength signal is lower than the threshold according to the procedure 26 for determining the received signal strength, supplying power to the receiving circuit block 20 is stopped according to the procedure 27 for stopping supplying power to the receiving circuit block. Meanwhile, when it is determined that the received signal strength signal is lower than the threshold, supplying power to the receiving circuit block 20 may not be stopped.

When it is determined that the identifying signal is not matched therewith according to the procedure 32 for determining the identifying signal, supplying power to the receiving circuit block 20, the demodulating circuit block 21, and the identifying signal determination circuit block 22 is stopped according to the procedure 33 for stopping supplying power to the receiving circuit block, the demodulating circuit block, and the identifying signal determination circuit block. Meanwhile, when it is determined that the identifying signal is not matched therewith, supplying power to the receiving circuit block 20, the demodulating circuit block 21, and the identifying signal determination circuit block 22 may not be stopped.

Conventionally, intermittent reception has been performed in the state where synchronization has been taken between the radio communication apparatuses. As opposed to this, according to the control method of this embodiment, when performing the intermittent reception operation in arbitrary time under out of synchronization and in standby mode, the received signal strength and the identifying signal are determined in this order, and when they are determined to be a desired reception signal according to the determination result, supplying power to each circuit block is sequentially started. In the intermittent reception operation in standby mode, supplying only power to required circuit blocks is started by repeating this operation, so that an unnecessary current can be reduced.

In particular, in an environment where the received signal includes few noise, the noise determination procedure is not performed, so that a reduction in time can be achieved, thereby making it possible to further reduce an unnecessary current in standby mode, and reduce head of line blocking of communication due to the off-time in intermittent reception mode.

### Eighth Embodiment

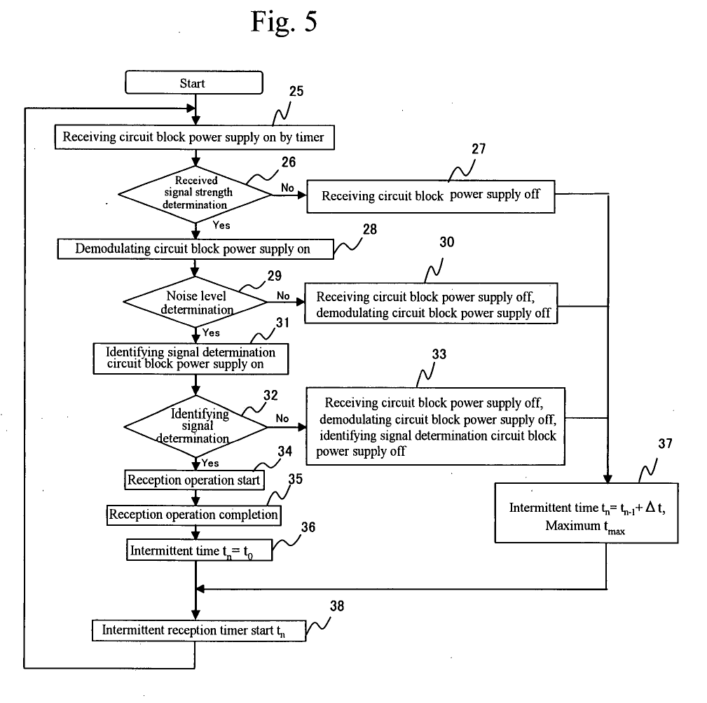

FIG. 5 is a flow chart showing an intermittent reception control method of an eighth embodiment of the present invention. Speaking more specifically, it is the flow chart showing a method of controlling power in the radio communication apparatus which performs intermittent reception shown in FIG. 1. This flow chart is obtained by adding a reception operation completion procedure 35, an intermittent reception timer time setting procedure 36 which is a procedure to control the time of intermittent reception, another intermittent reception timer time setting procedure 37, and an intermittent reception timer start procedure 38 to the flow chart which shows the control method according to the second embodiment and the fifth embodiment (FIG. 2). Incidentally, although explanation will not given in particular, a flow chart provided by adding above respective procedures 35, 36, 37, and 38 to the flow chart which shows the control method according to the third embodiment and the sixth embodiment (FIG. 3) can also be included as an embodiment. Similarly, a flow chart provided by adding above respective procedures 35, 36, 37, and 38 to the flow chart which shows the control method according to the fourth embodiment and the seventh embodiment (FIG. 4) can also be included as an embodiment.

In the flow chart shown in FIG. 5, since the control method from the procedure 25 for activating supplying power to the receiving circuit block by the timer circuit 17 to the procedures 27, 30, and 33 for stopping supplying power to each circuit block and the reception operation start procedure 34 is the same as that of the second embodiment and the fifth embodiment, explanation will be omitted.

When communication is not established with each of determination procedures 26, 29, and 32, according to the procedures 27, 30, and 33 for stopping supplying power to each circuit block, supplying power to the receiving circuit block 20, the demodulating circuit block 21, and the identifying signal determination circuit block 22 is stopped, and then according to the intermittent reception timer time setting procedure 37, a preset timer setting time is changed. Specifically, time increment Δt is added to timer time tₙ₋₁ set on the timer last time, next timer time tₙ is set to the timer circuit 17 as tₙ=tₙ₋₁+Δt. According to the intermittent reception timer start procedure 38, counting time of timer time tₙ is then started. However, timer time tₙ will be set not to exceed a preset maximum value tₘₐₓ.

The reception operation is started according to the reception operation start procedure 34, and when the reception operation is completed according to the reception operation completion procedure 35 after that, according to the intermittent reception timer time setting procedure 36, timer time tₙ is set to a minimum value to and according to the intermittent reception timer start procedure 38, counting time of timer time tₙ is started.

In FIG. 1, also when the transmitting circuit 18 performs transmission by a transmission seizing signal, it is considered that communication is performed, so that after the transmission is completed, timer time tₙ is set to a minimum value t₀ according to the intermittent reception timer time setting procedure 36, and counting time is started by assuming that the timer time is tₙ according to the intermittent reception timer start procedure 38.

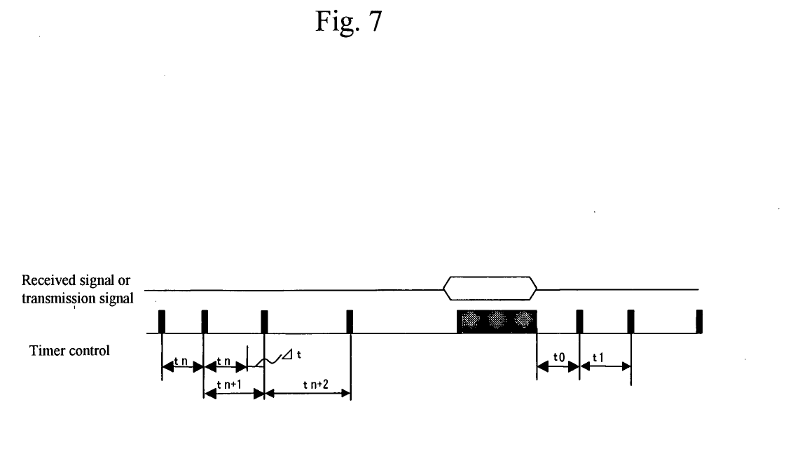

FIG. 7 is a timing chart showing that the timer time (off-time in intermittent reception) changes in this embodiment. In FIG. 7, in a state where no received signal is received, the timer time sequentially increases by Δt as tₙ→tₙ₊₁ (=tₙ+Δt)→tₙ₊₂ (=tₙ₊₁+Δt)→ . . . It is shown that when there is then provided a transmission signal or a received signal, the timer time becomes minimum value to immediately after that, and then increases after that as t₀→tₙ (=t₀+Δt) . . .

As described above, according to the control method in this embodiment, as shown in FIG. 7, an interval of the off-time in intermittent reception can be varied according to communication frequency. As a result, while communicating with each other, the off-time in intermittent reception is reduced, thereby making it possible to reduce head of line blocking of communication. Meanwhile, in a situation where communication is not performed, the off-time in intermittent reception is set longer, so that a reduction in consumed electric current can be achieved.

Other effects are similar to that of the second embodiment.

### Ninth Embodiment

According to a semiconductor integrated circuit for wireless communications of a ninth embodiment of the present invention, all or a part of the receiving circuit block 20, the demodulating circuit block 21, the identifying signal determination circuit block 22, the audio circuit block 23 (except for the loudspeaker 9), the transmitting circuit 18, the intermittent time control circuit 16, the timer circuit 17, and the power supply control circuit 10 including the radio communication apparatus of the above first embodiment are integrated on a semiconductor substrate. Specifically, this semiconductor integrated circuit for wireless communications is provided by integrating on the semiconductor substrate all or a part of the circuits in FIG. 1 excluding the antenna ANT, the loudspeaker 9, and band pass filters 7A through 7C and 7F, thereby making it possible to perform the intermittent reception control shown in first embodiment.

The semiconductor integrated circuit for wireless communications of this embodiment provides an effect similar to that of the first embodiment.

### 10th Embodiment

According to a module for wireless communications of a 10th embodiment of the present invention, all or a part of the receiving circuit block 20, the demodulating circuit block 21, the identifying signal determination circuit block 22, the audio circuit block 23 (except for the loudspeaker 9), the transmitting circuit 18, the intermittent time control circuit 16, the timer circuit 17, and the power supply control circuit 10 including the radio communication apparatus of the above first embodiment are mounted on a circuit board. Specifically, this module for wireless communications is provided by integrating on the circuit board (or semiconductor substrate) all or a part of the circuits in FIG. 1 excluding the antenna ANT, the loudspeaker 9, and band pass filters 7A through 7C and 7F, and thereby making it possible to perform the intermittent reception control shown in first embodiment.

The semiconductor integrated circuit for wireless communications of this embodiment provides an effect similar to that of the first embodiment.

### Embodiment 11

According to a radio communication system of an 11th embodiment of the present invention, in a radio communication system which directly communicates between a plurality of radio communication apparatuses or base stations without using a synchronized signal provided by a base transceiver station, the radio communication apparatus of first embodiment is used as the radio communication apparatus. As the control method of the radio communication apparatus shown in the first embodiment, any one of the methods shown in the second embodiment through the eighth embodiment is employed.

### INDUSTRIAL AVAILABILITY

The radio communication apparatus in accordance with the present invention is useful for reducing head of line blocking of conversation in intermittent reception in a reception standby state and thereby achieving a reduction in consumed electric current in a mobile radio apparatus that uses a frequency modulation scheme or the like.

1. A radio communication apparatus, comprising: a plurality of signal processing circuit blocks, which process a received signal provided through an antenna, at least one of which outputs a reception state determination signal to determine a reception state, and each of which has a different function; a timer circuit which counts an off-time in intermittent reception; and a power supply control circuit which controls supplying power to said plurality of signal processing circuit blocks according to states of an output signal of said timer circuit and said reception state determination signal.

2. The radio communication apparatus according to claim 1, wherein
a first signal processing circuit block of said plurality of signal processing circuit blocks is a receiving circuit block, which receives the signal through said antenna to produce an intermediate frequency signal and to also produce a received signal strength signal which indicates an intensity of an radio wave to be received,
a second signal processing circuit block of said plurality of signal processing circuit blocks is a demodulating circuit block, which demodulates the intermediate frequency signal outputted from said receiving circuit block to produce a baseband signal and to also produce a noise level determination signal which indicates whether a noise detection signal corresponding to a noise level in said baseband signal is larger than a threshold, and
a third signal processing circuit block of said plurality of signal processing circuit blocks is an identifying signal determination circuit block, which produces an identifying signal determination signal which indicates whether the signal is from a desired remote station based on an identifying signal contained in said baseband signal,
wherein said reception state determination signal includes said received signal strength signal, said noise level determination signal, and said identifying signal determination signal, and
said power supply control circuit controls a start and a stop of supplying power to said receiving circuit block, said demodulating circuit block, and said identifying signal determination circuit block according to states of the output signal of said timer circuit, said received signal strength signal, said noise level determination signal, and said identifying signal determination signal.

3. The radio communication apparatus according to claim 1, wherein
a first signal processing circuit block of said plurality of signal processing circuit blocks is a receiving circuit block, which receives the signal through said antenna to produce an intermediate frequency signal and to also produce a received signal strength signal which indicates an intensity of an radio wave to be received, and
a second signal processing circuit block of said plurality of signal processing circuit blocks is a demodulating circuit block, which demodulates the intermediate frequency signal outputted from said receiving circuit block to produce a baseband signal and to also produce a noise level determination signal which indicates whether a noise detection signal corresponding to a noise level in said baseband signal is larger than a threshold,
wherein said reception state determination signal includes said received signal strength signal and said noise level determination signal, and
said power supply control circuit controls a start and a stop of supplying power to said receiving circuit block and said demodulating circuit block according to states of the output signal of said timer circuit, said received signal strength signal, and said noise level determination signal.

4. The radio communication apparatus according to claim 1, wherein
a first signal processing circuit block of said plurality of signal processing circuit blocks is a receiving circuit block, which receives the signal through said antenna to produce an intermediate frequency signal and to also produce a received signal strength signal which indicates an intensity of an radio wave to be received,
a second signal processing circuit block of said plurality of signal processing circuit blocks is a demodulating circuit block, which demodulates the intermediate frequency signal outputted from said receiving circuit block to produce a baseband signal, and
a third signal processing circuit block of said plurality of signal processing circuit blocks is an identifying signal determination circuit block, which produces an identifying signal determination signal which indicates whether the signal is from a desired remote station based on an identifying signal contained in said baseband signal,
wherein said reception state determination signal includes said received signal strength signal and said identifying signal determination signal, and
said power supply control circuit controls a start and a stop of supplying power to said receiving circuit block and said identifying signal determination circuit block according to states of the output signal of said timer circuit, said received signal strength signal, and said identifying signal determination signal.

5. The radio communication apparatus according to claim 2, wherein said power supply control circuit stops supplying power to said receiving circuit block when said received signal strength signal is smaller than a predetermined threshold, stops supplying power to said demodulating circuit block in response to said noise level determination signal when said noise detection signal is larger than a predetermined threshold, and stops supplying power to said identifying signal determination circuit block in response to said identifying signal determination signal when said identifying signal does not indicate a desired remote station.

6. The radio communication apparatus according to claim 3, wherein said power supply control circuit stops supplying power to said receiving circuit block when said received signal strength signal is smaller than a predetermined threshold, and stops supplying power to said demodulating circuit block in response to said noise level determination signal when said noise detection signal is larger than a predetermined threshold.

7. The radio communication apparatus according to claim 4, wherein said power supply control circuit stops supplying power to said receiving circuit block when said received signal strength signal is smaller than a predetermined threshold, and stops supplying power to said identifying signal determination circuit block in response to said identifying signal determination signal when said identifying signal does not indicate a desired remote station.

8. The radio communication apparatus according to claim 2, further comprising an audio circuit block which converts said baseband signal into an audible output as a fourth signal processing circuit block of said plurality of digital processing circuit blocks,
wherein said power supply control circuit starts supplying power to said demodulating circuit block when said received signal strength signal is larger than a predetermined threshold, starts supplying power to said identifying signal determination circuit block in response to said noise level determination signal when said noise detection signal is smaller than a predetermined threshold, and starts supplying power to said audio circuit block in response to said identifying signal determination signal when said identifying signal indicates a desired remote station.

9. The radio communication apparatus according to claim 3, further comprising an audio circuit block which converts said baseband signal into an audible output as a fourth signal processing circuit block of said plurality of digital processing circuit blocks,
wherein said power supply control circuit starts supplying power to said demodulating circuit block when said received signal strength signal is larger than the predetermined threshold, and starts supplying power to said audio circuit block in response to said noise level determination signal when said noise detection signal is smaller than the predetermined threshold.

10. The radio communication apparatus according to claim 4, further comprising an audio circuit block which converts said baseband signal into an audible output as a fourth signal processing circuit block of said plurality of digital processing circuit blocks,
wherein said power supply control circuit starts supplying power to said identifying signal determination circuit block when said received signal strength signal is larger than a predetermined threshold, and starts supplying power to said audio circuit block in response to said identifying signal determination signal when said identifying signal indicates a desired remote station.

11. The radio communication apparatus according to claim 2, further comprising an intermittent time control circuit which controls an off-time in intermittent reception, wherein in response to a reception halt due to stopping supplying power from said power supply control circuit to any one of said receiving circuit block, said demodulating circuit block, and said identifying signal determination circuit block, said intermittent time control circuit extends the off-time in intermittent reception by a certain period of time, and in response to reception completion, controls a timer setting time of said timer circuit so as to reset said off-time in intermittent reception to a minimum value.

12. The radio communication apparatus according to claim 3, further comprising an intermittent time control circuit which controls an off-time in intermittent reception, wherein in response to a reception halt due to stopping supplying power from said power supply control circuit to either of said receiving circuit block or said demodulating circuit block, said intermittent time control circuit extends the off-time in intermittent reception by a certain period of time, and in response to reception completion, controls a timer setting time of said timer circuit so as to reset said off-time in intermittent reception to a minimum value.

13. The radio communication apparatus according to claim 4, further comprising an intermittent time control circuit which controls an off-time in intermittent reception, wherein in response to a reception halt due to stopping supplying power from said power supply control circuit to either of said receiving circuit block, or said identifying signal determination circuit block, said intermittent time control circuit extends the off-time in intermittent reception by a certain period of time, and in response to reception completion, controls a timer setting time of said timer circuit so as to reset said off-time in intermittent reception to a minimum value.

14. The radio communication apparatus according to any one of claims 2, 3, or 4, further comprising a transmitting circuit, which generates a transmission signal with a transmission seizing signal to transmit it through said antenna; and an antenna switch, which switches transmission/reception by selectively connecting said antenna to said receiving circuit block or said transmitting circuit.

15. An intermittent reception control method of controlling supplying power to a radio communication apparatus comprising a plurality of signal processing circuit blocks, at least one of which outputs a reception state determination signal to determine a reception state, and each of which has a different function, and performing intermittent reception, wherein supplying power to said plurality of signal processing circuit blocks is controlled according to a state of said reception state determination signal.

16. An intermittent reception control method of controlling supplying power to a radio communication apparatus, comprising: a receiving circuit block; a demodulating circuit block; and an identifying signal determination circuit block, and performing intermittent reception,
wherein based on a received signal strength signal which indicates an intensity of an radio wave to be received, a noise detection signal which indicates a noise level in a demodulation signal to be demodulated, and an identifying signal contained in a demodulation signal, firstly, it is determined whether said received signal strength signal is smaller than a predetermined threshold, then when said received signal strength signal is smaller than the predetermined threshold, supplying power to said receiving circuit block is stopped, secondly, it is determined whether said noise detection signal is larger than a predetermined threshold, then when said noise detection signal is larger than the predetermined threshold, supplying power to said demodulating circuit block is stopped, and finally, it is determined whether said identifying signal indicates a desired remote station, then when said identifying signal does not indicate the desired remote station, supplying power to said identifying signal determination circuit block is stopped.

17. The intermittent reception control method according to claim 16, wherein when said noise detection signal is larger than the predetermined threshold, supplying power to said receiving circuit block is stopped, and then when the identifying signal does not indicate the desired remote station, supplying power to said receiving circuit block is stopped, and supplying power to said demodulating circuit block is also stopped.

18. An intermittent reception control method of controlling supplying power to a radio communication apparatus, comprising: a receiving circuit block; and a demodulating circuit block, and performing intermittent reception,
wherein based on a received signal strength signal which indicates an intensity of an radio wave to be received, and a noise detection signal which indicates a noise level in a demodulation signal to be demodulated, it is determined whether said received signal strength signal is smaller than a predetermined threshold, then when said received signal strength signal is smaller than the predetermined threshold, supplying power to said receiving circuit block is stopped, and next, it is determined whether said noise detection signal is larger than a predetermined threshold, then when said noise detection signal is larger than the predetermined threshold, supplying power to said demodulating circuit block is stopped.

19. The intermittent reception control method according to claim 18, wherein when said noise detection signal is larger than the predetermined threshold, supplying power to said receiving circuit block is stopped.

20. An intermittent reception control method of controlling supplying power to a radio communication apparatus, comprising: a receiving circuit block; a demodulating circuit block; and an identifying signal determination circuit block, and performing intermittent reception,
wherein based on a received signal strength signal which indicates an intensity of an radio wave to be received, and an identifying signal contained in said demodulation signal, it is determined whether said received signal strength signal is smaller than a predetermined threshold, then when said received signal strength signal is smaller than the predetermined threshold, supplying power to said receiving circuit block is stopped, and next, it is determined whether said identifying signal indicates a desired remote station, then when said identifying signal does not indicate the desired remote station, supplying power to said identifying signal determination circuit block is stopped.

21. The intermittent reception control method according to claim 20, wherein when the identifying signal does not indicate the desired remote station, supplying power to said receiving circuit block is stopped, and supplying power to said demodulating circuit block is also stopped.

22. An intermittent reception control method of controlling supplying power to a radio communication apparatus, comprising: a receiving circuit block; a demodulating circuit block; an identifying signal determination circuit block; and an audio circuit block, and performing intermittent reception,
wherein based on a received signal strength signal which indicates an intensity of an radio wave to be received, a noise detection signal which indicates a noise level in a demodulation signal to be demodulated, and an identifying signal contained in a demodulation signal, firstly, it is determined whether said received signal strength signal is larger than a predetermined threshold, then when said received signal strength signal is larger than the predetermined threshold, supplying power to said demodulating circuit block is started, secondly, it is determined whether said noise detection signal is smaller than a predetermined threshold, then when said noise detection signal is smaller than the predetermined threshold, supplying power to said identifying signal determination circuit block is started, and finally, it is determined whether said identifying signal indicates a desired remote station, then when said identifying signal indicates the desired remote station, supplying power to said audio circuit block is started.

23. An intermittent reception control method of controlling supplying power to a radio communication apparatus, comprising: a receiving circuit block; a demodulating circuit block; and an audio circuit block, and performing intermittent reception,
wherein based on a received signal strength signal which indicates an intensity of an radio wave to be received, and a noise detection signal which indicates a noise level in a demodulation signal to be demodulated, it is determined whether said received signal strength signal is larger than a predetermined threshold, then when said received signal strength signal is larger than the predetermined threshold, supplying power to said demodulating circuit block is started, and next, it is determined whether said noise detection signal is smaller than a predetermined threshold, then when said noise detection signal is smaller than the predetermined threshold, supplying power to said audio circuit block is started.

24. An intermittent reception control method of controlling supplying power to a radio communication apparatus, comprising: a receiving circuit block; a demodulating circuit block; an identifying signal determination circuit block; and an audio circuit block, and performing intermittent reception,
wherein based on a received signal strength signal which indicates an intensity of an radio wave to be received, and an identifying signal contained in said demodulation signal, it is determined whether said received signal strength signal is larger than a predetermined threshold, then when said received signal strength signal is larger than the predetermined threshold, supplying power to said identifying signal determination circuit block is started, and next, it is determined whether said identifying signal indicates a desired remote station, then when said identifying signal indicates the desired remote station, supplying power to said audio circuit block is started.

25. The intermittent reception control method according to any one of claims 22, 23, or 24, wherein supplying power to said receiving circuit block is periodically started.

26. An intermittent reception control method, wherein when a received signal is not received for a predetermined time period or longer, an off-time in intermittent reception is set longer, and the off-time in intermittent reception is set shorter for a predetermined time period after reception completion or transmission completion.

27. An intermittent reception control method, wherein an off-time in intermittent reception is varied longer gradually with the passage of time after reception completion or transmission completion.

28. A semiconductor integrated circuit device for wireless communications, wherein the radio communication apparatus according to any one of claims 1 to 4 is integrated on a semiconductor substrate.

29. A module for wireless communications, wherein the radio communication apparatus according to any one of claims 1 to 4 is mounted on a circuit board.

30. A radio communication system employing the radio communication apparatus according to any one of claims 1 to 4.
